(19) United States
(12) Patent Application Publication
(10) Pub. No.: US 2008/0121475 A1
(43) Pub. Date: May 29, 2008

(54) Aircraft brake temperature reduction using heat transferring device

(75) Inventor: Mohan Bhaskara, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/604,511

(22) Filed: Nov. 27, 2006

(51) Int. Cl. F16D 65/853

(52) U.S. Cl. 188/264 CC

(57) ABSTRACT

A substantially hollow, closed container includes within it a capillary structure and a fluid. The container is adapted for positioning in proximity to a piece of equipment from which heat needs to be removed. In one embodiment, the container is positioned near a heat shield of a vehicular brake component.

### TECHNICAL FIELD

Various embodiments relate to heat dissipating devices, and in an embodiment, but not by way of limitation, a heat dissipating device that removes heat from brake components, and in particular, aircraft brake components.

### BACKGROUND

Heat dissipating devices are used in many industrial settings. For example, braking systems for vehicles generate a tremendous amount of heat. This is particularly true of brakes for aircraft, mainly because of the weight of the aircraft, the speed of the aircraft, and the rather long braking distance needed to stop the aircraft. The inability of a braking system to effectively remove heat from the system components may result in failure of the brakes, resulting in serious consequences.

The art would therefore benefit from a system that effectively removes heat from industrial equipment such as the removal of heat from brakes generated during the usage of those brakes.

### BRIEF DESCRIPTION OF THE DRAWINGS

FIG. 1 illustrates an example embodiment of a device that removes heat from mechanical equipment.

FIG. 2 illustrates an example embodiment of the device of FIG. 1 positioned in connection with a typical brake drum.

FIGS. 3A and 3B illustrate an example embodiment of the device of FIG. 1 positioned in connection with a heat shield.

### SUMMARY

A substantially hollow, closed container includes within it a capillary structure and a fluid. The container is adapted for positioning in proximity to a piece of equipment from which heat needs to be removed. In one embodiment, the container is positioned near a heat shield of a vehicular brake component.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

One or more embodiments of the present disclosure relate to a device for removing heat from industrial equipment such as vehicular brakes. In an embodiment, the device is used in connection with the brakes on an aircraft.

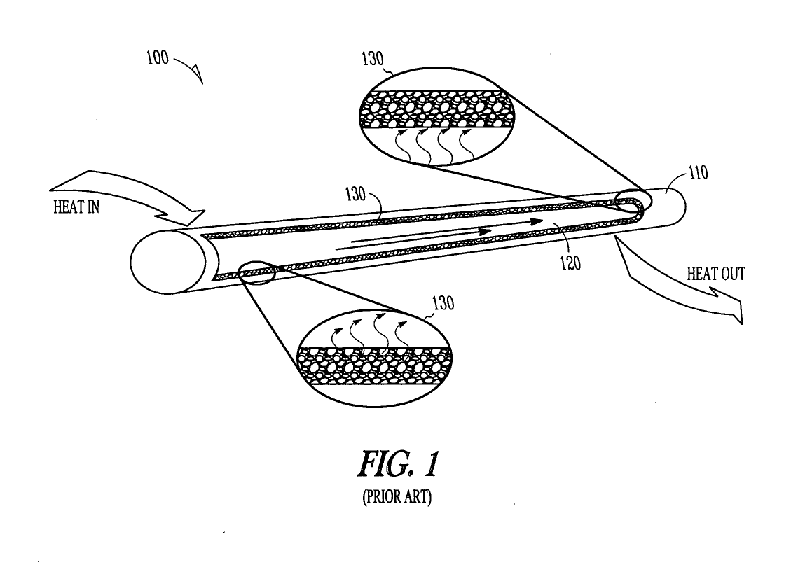

FIG. 1 illustrates an example embodiment of a heat dissipation device 100. The device 100 includes three primary parts—a heat conducting container 110, a phase changing and heat absorbing fluid 120 contained within the container 110, and a capillary or wick structure 130. In an example embodiment, the container 110 may be manufactured out of any heat conducting material such as copper, aluminum, and stainless steel. The phase changing and heat absorbing liquid 120 may be water, an ethylene glycol-water mixture, toluene, etc. The capillary or wick structure 130 may be made out of copper, steel, aluminum, or nickel mesh. The pore sizes of the mesh may vary from a range of approximately 2 to 30 meshes per linear inch. The mesh may further include fibrous materials such as ceramics and carbon fiber filaments.

In a particular embodiment, the capillary, wick, or mesh structure 130 is inserted into the heat conducting container 110. The container is then filled with the fluid 120, and the container 110 is sealed under pressure. In an embodiment, the pressure within the container 110 may be suitably reduced below atmospheric pressure. In an embodiment, the liquid is drawn into the container because of negative pressure created in the container by a simple vacuum pump.

When the example embodiment is a pipe, the pipe is sealed at one end, the mesh is inserted into the pipe at the open end, the liquid is drawn into the pipe via the negative pressure, and the other end of the pipe is sealed. One end of the pipe is referred to as an evaporator end, and the other end of the pipe is referred to as a condenser end.

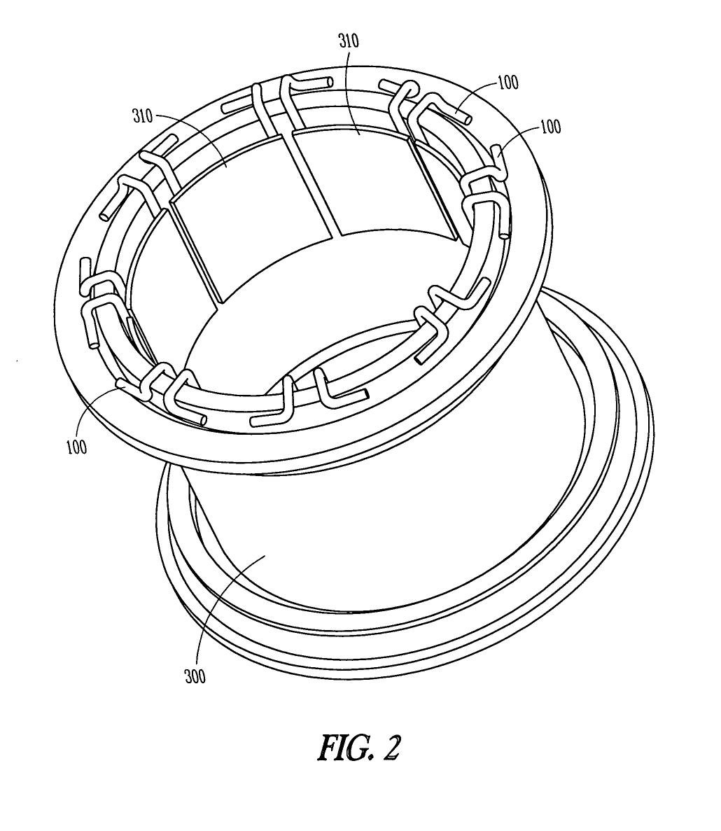

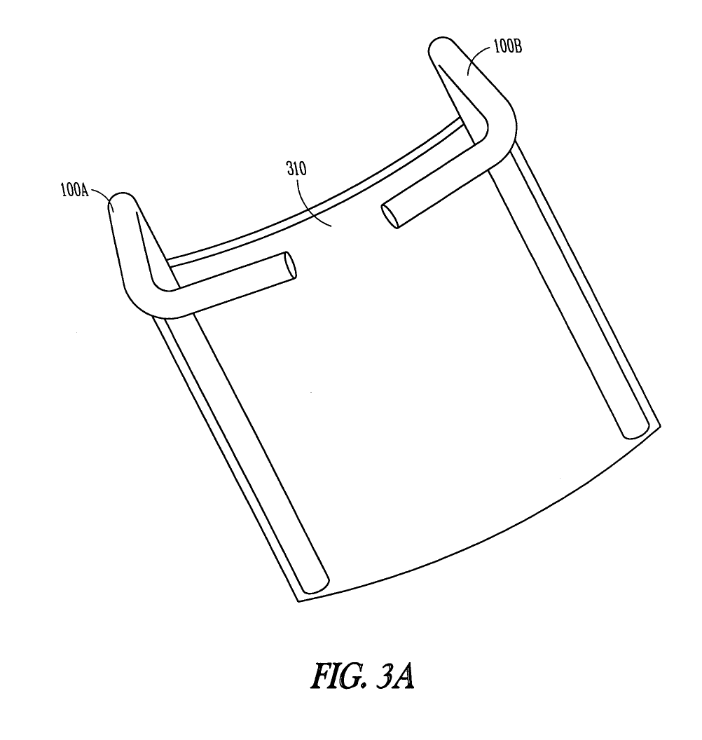

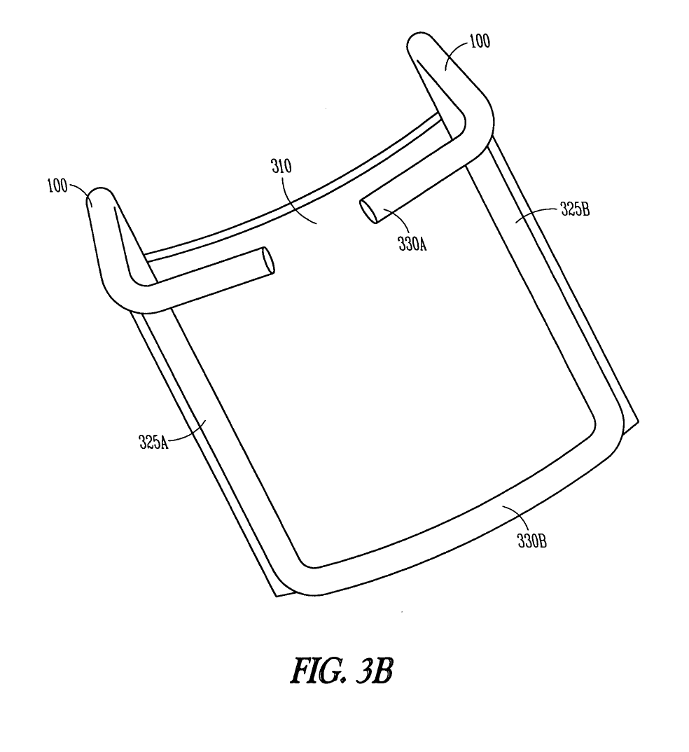

In an example embodiment in which the heat dissipating device 100 is used in connection with the brakes on an aircraft, the container is adapted to the required length and shape, and it is then inserted into existing heat shields in the aircraft brake drum. This arrangement is illustrated in FIGS. 2, 3A, and 3B. Referring to FIG. 2, a brake drum 300 includes one or more heat shields 310. One or more heat dissipation devices 100 are positioned between the heat shields 310 and the brake drum 300.

FIGS. 3A and 3B illustrate an example of the position of the heat dissipating device 100 and a brake heat shield 310. In FIG. 3A, two individual devices 100A and 100B are positioned in proximity to a heat shield 310. In one embodiment, the heat shield is shaped to receive and mate with the devices 100A and 100B. In the embodiment of FIG. 2, the heat from the brake drum will dissipate to the evaporator portion of the heat dissipating devices 100A and 100B, as shown in FIG. 3A. The evaporator portion of the heat dissipating devices are primarily those portions of the devices which are in contact with the brake drum. The liquid in the evaporator portion of the device evaporates, and dissipates via the mesh (not shown in FIG. 3A) to the condenser segment of the heat dissipating devices. In the embodiment of FIG. 3A, the condenser portion of the heat dissipating devices 100A and 100B are those segments that are exposed to cooler atmospheric air. The heated liquid in the condenser portion gives up its heat to the environment surrounding the condenser portion, and the condensed liquid returns to the evaporator segment to begin the cycle again.

FIG. 3B illustrates another embodiment of a heat dissipating device 100 positioned in proximity to a heat shield 310. The embodiment of FIG. 3B includes a single heat dissipating device 100 positioned in proximity to a heat shield 310. The device 100 includes three evaporator segments 325A, 325B, and 330B, and two condenser segments 330A and 100. As previously disclosed, the heat from the heat shield will cause the liquid in the evaporator section to evaporate and dissipate to the condenser sections. The liquid will condense in the condenser section, and return via the mesh within the device to the evaporator sections 325A, 325B, and 330B.

Therefore, in general, heat generated by a brake will be transferred from the brake drum, heat shield, and other components of the brake system to the device 100. The heat causes the liquid in the evaporator end of the device 100 to vaporize. When this occurs, latent heat dissipates to the condenser end of the pipe, where the heat from the liquid is dissipated to the atmosphere and the liquid condenses. After condensation, the liquid is returned to the evaporator by the mesh via capillary action of the mesh.

As shown in FIGS. 3A and 3B, the heat dissipating device 100 may be formed or shaped such as to mate with a heat shield. The heat dissipating device may be secured in place by attachment to the heat shield and brake drum. This can be done via connecting means such as bolts or other means such as welding. In another embodiment, it may be attached and secured to other structures that are part of the brake system or that are in proximity to the brake system. As can be gleaned from FIGS. 3A and 3B, the length and shape of the device 100 are determined by the components of the brake system and the surrounding environment.

While the present disclosure deals primarily with heat dissipation devices used in connection with vehicular brakes, one of skill in the art will realize that embodiments of the present disclosure may be used in connection with other apparatuses from which there is a need to remove heat.

In the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. An apparatus comprising:
a substantially hollow, closed container;
a capillary structure positioned within said container; and
a fluid contained within said container;
wherein a portion of said container is adapted for positioning in proximity to mechanical equipment for the removal of heat from said equipment.

2. The apparatus of claim 1, wherein said mechanical equipment comprises a vehicular brake component.

3. The apparatus of claim 2, wherein said vehicular brake component comprises a brake drum.

4. The apparatus of claim 3, wherein a portion of said container is adapted for extending outside of said brake drum.

5. The apparatus of claim 3, wherein said vehicular brake drum comprises an aircraft brake drum.

6. The apparatus of claim 1, wherein said container comprises a longitudinal pipe, the longitudinal pipe sealed at a first end and a second end.

7. The apparatus of claim 6, further wherein said pipe comprises copper, aluminum, or stainless steel.

8. The apparatus of claim 1, wherein said capillary structure comprises a copper mesh, an aluminum mesh, a steel mesh, a nickel mesh, a ceramic filament, or a carbon fiber filament.

9. The apparatus of claim 1, wherein said fluid includes one or more of water, an ethylene-glycol and water mixture, and toluene.

10. The apparatus of claim 1, wherein said fluid in said container is under pressure.

11. An apparatus comprising:
a substantially hollow body;
a mesh positioned inside of said body; and
a liquid filling said body;
wherein the body is adapted for attachment to a vehicular brake system.

12. The apparatus of claim 11, wherein said body comprises one or more of a copper, an aluminum, and a steel pipe, and further wherein said pipe comprises a circular, square, or rectangular cross section.

13. The apparatus of claim 11, wherein the body is longitudinal.

14. The apparatus of claim 11, wherein said mesh comprises one or more of copper, aluminum, steel, carbon, nickel, and ceramic fibers.

15. The apparatus of claim 11, wherein said liquid comprises distilled water, a mixture of ethylene and distilled water, or toluene.

16. The apparatus of claim 11, wherein said liquid in said body is under pressure.

17. The apparatus of claim 16, wherein said pressure is suitably reduced below atmospheric pressure.

18. The apparatus of claim 11, wherein said body is attached to a heat shield of an aircraft brake drum.

19. An apparatus comprising:
a substantially hollow, closed container;
a capillary structure positioned within said container; and
a fluid contained within said container;
wherein a portion of said container is adapted for positioning in proximity to an aircraft brake component.

20. The apparatus of claim 19, wherein the aircraft brake component includes one or more of a brake drum and a heat shield.
